(19) United States
(12) Patent Application Publication
(10) Pub. No.: US 2008/0206414 A1
(43) Pub. Date: Aug. 28, 2008

(54) PRESERVATIVE METHOD

(75) Inventors: Bernard Charles SEKULA, Glen Gardner, NJ (US); Michael Charles CIRIGLIANO, Cresskill, NJ (US)

Correspondence Address: UNILEVER PATENT GROUP, 800 SYLVAN AVENUE, AG West S. Wing, ENGLEWOOD CLIFFS, NJ, 07632-3100, US

(73) Assignee: CONOPCO, INC., D/B/A UNILEVER, Englewood Cliffs, NJ (US)

(21) Appl. No.: 11/678,771

(22) Filed: Feb. 26, 2007

(51) Int. Cl. A21D 4/00

(52) U.S. Cl. 426/323

(57) ABSTRACT

A method for producing a microbiologically stable and safe food composition is described The method includes the step of mixing a food composition comprising an anionic polymer with a saturated preservative having an overall positive charge, whereby the saturated preservative is added in the last mixing step, in order to produce a food composition free of spoilage and pathogens.

### FIELD OF THE INVENTION

The present invention is directed to a preservative method. More particularly, the present invention is directed to a method for preserving a food composition comprising an anionic polymer with a preservative system that includes a saturated preservative having an overall positive charge, whereby the saturated preservative is added in the last mixing step, in order to produce a food composition free of spoilage and pathogens, i.e., that is microbiologically safe and stable.

### BACKGROUND OF THE INVENTION

Preservatives, like sorbate, benzoate and organic acids have been used in food products. Such preservatives offer a degree of microbiological inhibition.

However, conventional preservative systems, in order to be effective, require the presence of organic acids, low pH values, or both in order to achieve microbiological stability across a wide range of food compositions. While high levels of organic acid and/or low pH values can contribute to the stability of edible products, the use of the same almost invariably results in food compositions having inferior taste, olfactory and visual characteristics.

It is of increasing interest to develop a preservative system that may be used across a wide range of food compositions, especially ambient stable and chilled-food compositions that utilize anionic polymeric thickening agents to replace some or all of the oil or fat in the system. This invention, therefore, is directed to a method for preserving a food composition with a preservative system comprising a saturated preservative having an overall positive charge The method of this invention, unexpectedly, results in a microbiologically ambient stable food composition in the absence of organic acids. The method of this invention also, surprisingly, results in microbiologically safe chilled-food compositions, even at elevated pH values. Moreover, the method of this invention does not adversely impact the taste, olfactory and visual characteristics of the food compositions comprising the above-described preservative system.

In International Publication WO 03/094638, preservative and protective systems derived from lauric acid and arginine are described. This reference recognizes the phenomenon of precipitation of anionic hydrocolloids with LAE, a compound derived from lauric acid and arginine, which is an ethyl ester of the lauramide of arginine monohydrochloride. The present invention addresses this undesired interaction when LAE and anionic thickening components are combined and intimately mixed into a food composition.

### Additional Information

Efforts have been disclosed for making preservative systems, US Published Patent Application No. 2006/0177548 describes a method of producing a microbiologically stable and safe food composition.

Other efforts have been disclosed for making preservative systems. In International Publication WO 03/013454, preservative systems for cosmetic preparations are described,

Even other efforts have been disclosed for making microbiologically stable food compositions. In U.S. Pat. No. 6,036,986, cinnamic acid for use in tea-containing beverages is described.

None of the additional information above describes a method for using a saturated preservative having an overall positive charge with an anionic thickening polymer effective for use and co-mixing across a wide range of food compositions to render the same microbiologically stable and safe.

### SUMMARY OF THE INVENTION

In a first aspect, the present invention is directed to a method for preserving a food composition comprising,
providing a food composition comprising an anionic polymer; mixing said food composition with a preservative system comprising:
(a) about 20 ppm to about 200 ppm of said food composition of a cationic saturated preservative having an overall positive charge;
(b) optionally, from about 0.015 percent to about 0.500 percent by weight of said food composition of a second preservative component;
   wherein said saturated preservative having an overall positive charge is added to the food composition in the last mixing step;
      thereby rendering said food composition microbiologically safe and stable. In particular, the food composition displays no outgrowth of Lactobacilli, yeast and mold for at least three (3) months before opening and when kept at a temperature of 25° C. and at a pH of less than 4.2, or for at least (4) weeks before opening when kept at a pH of less than 6 at a temperature of 5° C., and prevents the outgrowth of pathogens, and achieves at least a 2 log decline of pathogens within about a seven (7) day period when kept at a pH from 3.0 to less than 5.0.

The second preservative component second preservative component may be a polyene macrolide antibiotic; or a compound having the formula II:

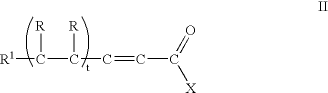

where

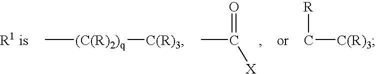

X⁽⁻⁾ is: a monohydrohalide, preferably chloride (Cl⁻);
R is independently a C₁-C₄ alkyl or hydrogen;
q is 0 to 12, and t is from 0 to 6, with the proviso that when R¹ forms part of an sp² hybridized carbon-carbon bond, t does not equal zero; most preferably sorbic acid. Further, aromatic preservatives suitable for use in this invention include, benzoic acid, coumaric acid, salicylic acid, vanillic acid, caffeic acid, cinnamic acid, ferulic acid, salts thereof, derivatives thereof, mixtures thereof. The second preservative component may also include acetic, propanoic, 2-hydroxypropanoic (lactic), butyric, propionic, phosphoric, valeric, adipic, gluconic, malic, citric, tartaric, ascorbic, carnosic acid or a mixture thereof.

Food composition, as used herein, means a composition suitable for consumption by humans, including a filling, dip, soup, sauce, spread, dressing, refrigerated salad, batter or beverage.

Microbiologically stable (i.e., spoilage free) means no outgrowth of spoilage bacteria, yeast and/or mold and no flavor loss for at least about three (3) months, and preferably, for at least about ten (10) months before opening when kept at about 25° C. and at a pH of less than about 4.2. When chilled, microbiologically stable means no outgrowth of spoilage bacteria, yeast and/or mold and no flavor loss for at least about four (4) weeks, and preferably, for at least about six (6) weeks before opening when kept at about 5° C. and a pH of less than 6.0.

Microbiologically safe (for products kept at about 25° C. and 5° C.) means preventing the outgrowth of pathogens and achieving at least about a 2 log die off of pathogens (like Listeria monocytogenes) within a fourteen (14) day period (preferably a seven (7) day period) when kept at a pH from about 3.0 to less than 6.0.

### Cationic Saturated Preservative

There is no limitation as to the saturated preservative, which includes cationic compounds including but not limited to quaternary compounds. Preferably, the saturated preservative used in this invention is suitable for human consumption, and preferably, has a pKₐ of under about 5.0. Saturated cationic preservative is used in the food compositions in amounts of about about 20 ppm to about 200 ppm.

Illustrative examples of the type of cationic saturated preservatives suitable for use in this invention include those having the formula I:

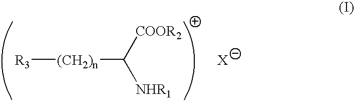

### Where:

R₁ is: a linear or branched alkyl chain from a saturated fatty acid or a saturated fatty hydroxy acid containing 8 to 14 carbon atoms bonded to the alpha-amino acid group through an amidic bond;
R₂ is: a linear or branched alkyl group containing 1 to 4 carbon atoms;
X⁽⁻⁾ is: a monohydrohalide, preferably chloride (Cl⁻);
R₃ is: a structure of formula Ia

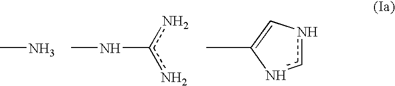

n is: from 1 to 4.

In a most preferred embodiment, the cationic saturated preservative is derived from lauric acid and arginine and is an ethyl ester of the lauramide of arginine monohydrochloride (LAE), whereby a more detailed description of the same may be found in U.S. Patent Application No. 2004/0265443 A1.

### Anionic Polymer

An anionic polymer is necessary in the food compositions of the present invention for mouthfeel. These are generally classified as thickening agents or gums. Thickening agents derived from cellulose may also be employed and they include carboxymethylcellulose, sodium carboxymethylcellulose, and mixtures of these polymers. The anionic polymer may have sulphate or, preferably, carboxylate groups. Although not limited thereto, preferably, the anionic polymer is xanthan gum or pectin, more preferably food grade xanthan gum.

Typically, anionic polymers make up from about 0.05 to about 1.0%, and preferably, from about 0.1 to about 0.75%, and most preferably, from about 0.125 to about 0.35% by weight of the total weight of the food composition, including all ranges subsumed therein.

### Xanthan Gum

Xanthan (otherwise called xanthan gum) is a microbial exopolysaccharide 20 produced by the naturally occurring bacterium Xanthomonas campestris. It is a widely used biopolymer in the food and pharmaceutical industries. It is also used in many other fields such as petroleum production, pipeline cleaning, enhanced oil recovery, textile printing and dyeing, ceramic glazes, slurry explosives and in cosmetics. It is used for the purposes of thickening, suspending, stabilizing and gelling.

Xanthan consists of a pentasaccharide repeating subunit. It consists of two D-glucopyranosyl units, two D-mannopyranosyl units and a D-glucopyranosyluronic acid as determined by methylation analysis and uronic acid degradation. The molecule has a (1→4) linked β-D-glucopyranosyl backbone as found in cellulose, with a trisaccharide side-chain attached to the O-3 position on alternate glucosyl units, The side chain is constructed such that the D-glucuronosyl unit is flanked by the two mannosyl units. Approximately half of the terminal D-mannosyl units have a pyruvic acid moiety across the O-4 and O-6 positions. The other D-mannosyl unit is substituted at the O-6 position with an acetal group. Xanthan is available readily as the sodium or potassium salt, or as mixtures of sodium, potassium or calcium salts. Xanthan has been estimated to have a molecular weight between 2-50×10⁶. This wide range of values is believed to be due to polymer chain association.

### Alginate

Another anionic polymer may be an alginate. Alginates may be found in and isolated from various organisms, in particular from algae belonging to the order Phaeophyceae and soil bacteria such as Azotobacter vinelandii and Azotobacter crococcum and from several strains of Pseudomonas bacteria. Common algal sources of alginates include Laminaria digitata, Ecklonia maxima, Macrocystis pyrifera, Lessonia nigrescens, Ascophyllum nodosum, Laminaria japonica, Durvillea antartica, Durvillea potatorum and, especially Laminaria hyperborea.

Alginic acid is a linear hetero-polysaccharide comprising units of β-D-mannuronic acid and α-L-guluronic acid. Alginic acid may comprise homopolymeric sequences of mannuronic acid, homopolymeric sequences of guluronic acid, and mixed sequences of mannuronic aid and guluronic acid units.

Salts of alginic acid used in the method of the present invention may include alkali metal salts, for example sodium and potassium salts, and ammonium and alkanolamine salts.

Preferred are water-swellable, preferably water soluble, salts of alginic acids. Most preferably they are provided as solutions, substantially without precipitates therein.

The term “alginates” as used herein includes salts of alginic acid, irrespective of the relative proportion of mannuronic and guluronic units, and is intended to include glycolated or alkoxylated derivatives, especially those derivatised with propylene glycol. However, preferred compounds are not alkoxylated or glycolated. Guluronic acid-rich alginic acid and guluronic acid-rich alginates are of particular interest.

### Insoluble Fibers

Regarding insoluble fibers suitable for use in this invention, such fibers are found, for example, in fruits, both citrus and non-citrus. Other sources of the insoluble fibers suitable for use in this invention are vegetables like legumes, and grains. Preferred insoluble fibers suitable for use in this invention can be recovered from tomatoes, peaches, pears, apples, plums, lemons, limes, oranges, grapefruits or mixtures thereof. Other preferred insoluble fibers suitable for use in this invention may be recovered from the hull fibers of peas, oats, barley, mustard, soy, or mixtures thereof. Still other fibers which may be employed include those that are plant or root-derived as well as those which are wood-derived. Typically, the food compositions, and particularly dressing compositions, of this invention comprise from 0.0 to about 3%, and preferably, from about 0 to about 2% by weight insoluble fibers, based on total weight of the food composition, and including all ranges subsumed therein. Such insoluble fibers are available from suppliers like J. Rettenmaier and Sohne GMBH under the Vitacel name and Herbstreith & Fox under the Herbacel name. These insoluble fibers typically have lengths from about 25 to about 400 microns, and preferably, from about 50 to 185 microns, and most preferably, from about 100 to about 165 microns, including all ranges subsumed therein. The widths of such fibers are typically between about 3.0 to about 20.0 microns, and preferably, from about 5.0 to about 10.0 microns. It is also within the scope of this invention for the insoluble fiber used to be supplied with from about 0 to 15% by weight soluble fiber, based on total weight of insoluble fiber and soluble fiber and including all ranges subsumed therein.

### Optional Preservatives

As to the optional (but often preferred) second preservative component, the same is limited only in that it may be employed in food compositions suitable for human consumption, and preferably, has a pKₐ of under about 5.5. The second preservative component is used in the food compositions in amounts of about 0.0% to about 0.500%, preferably about 0.015 to about 0.200, more preferably about 0.100 to about 0.200% by weight of the food composition.

Illustrative examples of unsaturated preservatives suitable for use in this invention as a second preservative component include those classified as a polyene macrolide antibiotic, as well as those having the formula:

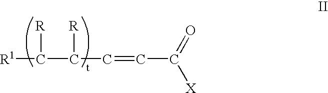

where

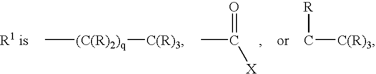

and R and X are as previously defined,
R is independently a C₁-C₄ alkyl or hydrogen, preferably hydrogen, q is 0 to about 12, and t is from 0 to about 6, with the proviso that when R¹ forms part of an sp² hybridized carbon-carbon bond, t does not equal zero. In a most preferred embodiment, the unsaturated preservative is a polyene macrolide antibiotic like natamycin (or pimaricin), a compound represented by II, like sorbic acid, propenoic acid, 2-hexenoic acid, fumaric acid, or a mixture thereof.

Regarding further optional (but often preferred) second preservative components, aromatic preservative preferably has a pKₐ of under about 5.0 and is water soluble. Illustrative and non-limiting examples of the aromatic preservatives suitable for use in this invention include, benzoic acid, coumaric acid, salicylic acid, vanillic acid, caffeic acid, cinnamic acid, ferulic acid, salts thereof, derivatives thereof, mixtures thereof. Normally, in order to exert an antimicrobial effect in the absence of other antimicrobial agents, at least about about 0.050 to about 0.200% by weight aromatic preservative is used as an additive.

The second preservative component may also include acetic, propanoic, 2-hydroxypropanoic (lactic), butyric, propionic, phosphoric, valeric, adipic, gluconic, malic, citric, tartaric, ascorbic, carnosic acid or a mixture thereof.

The total weight of preservative system employed in the food composition of this invention is limited only to the extent that the resulting food composition is microbiologically stable and safe as defined herein. Typically, however, the food compositions made via the method of this invention have from about 0.002 to about 1.5, and preferably, from about 0.005 to about 0.4, and most preferably, from about 0.01 to about 0.30 percent by weight preservative system (as pure preservative), based on total weight of food composition and including all ranges subsumed therein.

### Method

Applicants have discovered an optimized method of preparing reduced oil food formulations in order to achieve maximum anti-microbial effect from the saturated preservative having an overall positive charge. Note, reduced oil food formulations require the use of thickening agents. In the process according to the present invention, the saturated preservative having an overall positive charge is added last to the formulation. In other words, the formulation including anionic polymeric thickening agents (e.g. gums) is mixed first, followed by a last step of addition of the saturated preservative having an overall positive charge.

Without wishing to be bound by theory, Applicants believe that reserving cationic saturated preservative at the end permits the anionic sites on the anionic polymer, i.e. that would bind and/or precipitate the cationic preservative making it ineffective, to be taken up by other cations present in the system, including by not limited to hydrogen, sodium, potassium, calcium, and magnesium.

When conducting the method of this invention, components of the preservative system other than the saturated preservative can be combined with ingredients to make a food composition or combined with a food composition having already been prepared whereby combined is meant to optionally include marinating. Surprisingly, and again, when conducting the method of this invention, a food composition, like a filling, dip, sauce, spread, dressing, beverage or the like, is rendered microbiologically safe and stable in the absence of additional preservatives and at elevated pH values.

The food compositions made via the method of this invention, unexpectedly, are not sour even when the same are formulated to have a pH below 4.20, Such food compositions can comprise meat, fish, crustaceans, poultry products, bread crumbs, vegetables (including chunks and puree), protein, wheat, sweeteners (including sugar and artificial sweeteners), oil, emulsions, fruit (including chunks and puree), cheese, nuts, mixtures thereof or the like.

Illustrative and non-limiting examples of preferred food compositions prepared via the method of this invention include pourable dressings, fruit based compositions and mayonnaise comprising salads like coleslaw, tuna, macaroni, and chicken salad.

Most preferred compositions according to the present invention are pourable dressings and mayonnaise type dressings with reduced oil levels of about 65 % or less. The relatively low oil content of such dressings requires use of thickening agents in the formulation. Most effective thickening agents are comprised of molecules having an overall anionic charge, such as soluble fibers, insoluble fibers and gums. Preferred among these are xanthan gum and citrus fibers.

Preferred food compositions can also comprise starches, cellulose, vitamins, chelators, buffers, antioxidants, colorants, acidulants (including inorganic acids), emulsifiers, alcohol, water, spices (including salt), syrups, milk, food grade dispersants or stabilizers (like propylene glycol alginate), solubilizing agents (like propylene glycol), milk powder or mixtures thereof.

The packaging suitable for use with the food compositions made according to this invention is often a glass jar, food grade sachet, a plastic tub or squeezable plastic bottle. Sachets are preferred for food service applications, a tub is preferred for spreads and a squeezable plastic bottle is often preferred for non-spreads and domestic use.

The following examples are provided to illustrate an understanding of the present invention. The examples are not intended to limit the scope of the claims.

### EXAMPLE 1

Avocado-based compositions were made by mixing the following ingredients:

TABLE 1

| | Weight Percent of Formula |
|---|---|
| A. Ingredient-Oil Phase | |
| Soybean oil | 18.6 |
| Polysorbate 60 | 0.3 |
| B. Ingredient-Fiber Phase | |
| Water | 43.1 |
| Sorbic Acid | 0.10 |
| Citrus fiber | 2.60 |
| Potato starch | 1.00 |
| Milk powder | 0.75 |
| Gums | 0.21 |
| Corn syrup | 11.13 |
| EDTA | 0.007 |
| Color | 0.075 |
| Sugar | 1.00 |
| Salt | 1.02 |
| C. Ingredient-Intermediate Mix | |
| Fiber phase | 61.0 |
| Oil phase | 18.9 |
| Avocado flesh | 19.7 |
| Hydrochloric acid | 0.34 |
| Propylene glycol | 0.045 |
| Natamycin | 0.0004 |
| D. Ingredient-Final Mix | |
| LAE | 0.005 |
| | 100.0 |

Ingredients of the oil and fiber/intermediate phases were combined and mixed under moderate shear at atmospheric pressure and ambient temperature in a conventional mixer to produce a coarse emulsion. The coarse emulsion was then subjected to a homogenizer (e.g., APV Gaulin Homogenizer) pressurized to about 250 bar. The resulting emulsion was combined with the ingredients in the final mix to produce an avocado-based composition. The same was then subjected to a votator for about three (3) minutes at 75° C. resulting in an avocado-based composition having a pH of about 3.5.

### EXAMPLE 1A

Avocado-based compositions (pH ˜3.5) were made in a manner similar to the one described in Example 1 except that LAE was added in the intermediate mix in lieu of the final mix.

### EXAMPLE 1B

Avocado-based compositions (pH ˜3.5) were made in a manner similar to the one described in Example 1 except that 0.0005% by weight of nisin was used in lieu of LAE.

TABLE 2

| | APRYⁱ | LBLⁱⁱ | LBHⁱⁱⁱ |
|---|---|---|---|
| Example 1 | N | N | N |
| Example 1A | Y | N | Y |
| Example 1B | Y | N | N |

ⁱAcid preservative resistant yeast; initial inoculation about 100 cfu/g
ⁱⁱLactobaccilli low; initial inoculation about 100 cfu/g
ⁱⁱⁱLactobaccilli high; initial inoculation about 1000 cfu/g
N = no growth;
Y = growth
Cfu = colony forming unit

Table 2 shows the results of a stability/spoilage challenge study for the avocado-based compositions made in Examples 1, 1A, and 1B. The avocado-based composition of Example 1 was made in a manner consistent with the invention described herein. Surprisingly, no outgrowth of spoilage yeast and bacteria was observed for at least 3 months at the identified inoculation levels. Example 1A, an avocado-based composition with LAE added together with the fiber, shows the growth of yeast and bacteria within a three month period. Example 1B, an avocado-based composition with sorbic acid, nisin and natamycin, shows yeast growth within three months notwithstanding the presence of natamycin as an antifungal agent. The results show that food compositions are unexpectedly microbiologically stable and safe when subjected to the method of this invention.

### EXAMPLE 2

A blue cheese dressing having a pH of about 3.8 was made by mixing the following ingredients, with LAE being mixed last:

TABLE 3

| Ingredient | Weight Percent of Formula |
|---|---|
| Water | Balance |
| Soybean Oil | 43.0 |
| Vinegar (10%) | 6.01 |
| NaCl | 2.00 |
| Lactic acid (88%) | 0.372 |
| Flavor | 0.44 |
| Polysorbate 60 | 0.22 |
| Vitamin | 0.005 |
| Cheese crumbs | 12.0 |
| Sucrose | 1.96 |
| Dispersant | 0.174 |
| Potassium sorbate | 0.10 |
| Garlic Powder | 0.10 |
| EDTA | 0.007 |
| Gum | 0.70 |
| Propylene glycol | 0.045 |
| LAE | 0.005 |

### EXAMPLE 2A (COMPARATIVE)

The blue cheese dressing of this Example was made in a manner similar to the one described in Example 2, except that LAE was added together with all the ingredients, rather than at the end.

A spoilage study was conducted on the blue cheese dressings of Examples 2 and 2A. The dressing composition of Example 2, made in a manner consistent with this invention, showed no outgrowth of acid preservative resistant yeast and Lactobacilli at low and high initial inoculation levels (i.e., about 50 cfu/g and 5,000 cfu/g, respectively). The dressing composition of Example 2A displayed growth of spoilage yeast and Lactobacilli bacteria within one (1) week.

### EXAMPLE 3

Compositions were made by mixing the ingredients in Table 1 above, except that LAE and sorbic acid amounts were varied.

LAE was added at 0.001 weight percent of the formula and xanthan gum at 0.21%, and sorbic acid level was varied, as well as pH. Water was added as a BALANCE so that all the ingredients in the formulation add to 100.0%. This example explores the order of addition of LAE with and without presence of to xanthan gum, and at different pH.

Ingredients of the oil and fiber/intermediate phases were combined and mixed under moderate shear at atmospheric pressure and ambient temperature in a conventional mixer to produce a coarse emulsion. The coarse emulsion was then subjected to a homogenizer (e.g., APV Gaulin Homogenizer) pressurized to about 250 bar. The resulting emulsion was combined with the ingredients in the final mix to produce an avocado-based composition. The same was then subjected to a votator for about three (3) minutes at 75° C. resulting in a guacamole composition.

When LAE was mixed along with the other ingredients, either with or without xanthan gum, rather than as the final mix, the composition was microbiologically unstable. Sorbic acid was at 0.10% and pH was about 3.6. Specifically, lactobacilli and APRY yeast levels became unacceptably high.

When LAE was mixed along with the other ingredients, without xanthan gum, rather than as the final mix, with pH of about 3.4 and sorbic acid at 0.19%, the composition was microbiologically stable. Specifically, lactobacilli and APRY yeast levels were acceptable over a period of 8 weeks, i.e., no spoilage.

When LAE was mixed in last, with xanthan gum added earlier in the composition, with pH of about 3.47 and sorbic acid at about 0.15%, the composition was microbiologically stable. Specifically, lactobacilli and APRY yeast levels were acceptable over a period of 7 weeks, i.e., no spoilage. Moreover, no spoilage was seen when LAE amount was reduced to 0.00075 and sorbic acid level was reduced to 0.10% at about the same pH, thereby showing the favorable effect of mixing in LAE as a last step.

### EXAMPLE 4

Chicken salad compositions (pH ˜4.7) were made by combining the following ingredients, with LAE added as a last mixing step:

TABLE 4

| Ingredient | Weight Percent of formula |
|---|---|
| Water | Balance |
| LAE | 0.015 |
| Propylene glycol | 0.135 |
| Potassium sorbate | 0.100 |
| Sodium benzoate | 0.100 |
| Onion | 6.00 |
| Celery | 14.50 |
| Salt | 0.120 |
| Sugar | 2.20 |
| Black Pepper | 0.10 |
| Xanthan Gum | 0.20 |
| Bread Crumbs | 3.00 |
| HELLMANN'S brand Mayonnaise | 24.4 |
| Phosphoric acid | 0.79 |
| Chicken | 48.00 |

Storage studies of the same indicated no yeast or bacteria outgrowth for at least seven (7) weeks, even at temperatures of about 7° C. Safety studies also indicated at least a 2 log decline in pathogenic (Listeria monocytogenes) levels in about seven (7) days at 5° C., 7° C. and 10° C. In the control, in which LAE was omitted, lactic acid bacteria and yeast spoilage took place at between two (2) and four (4) weeks at 10° C. and 7° C., respectively. There was no decline in Listeria monocytogenes counts at 5° C. and 7° C., and outgrowth took place at between four and five weeks at 10° C.

### EXAMPLE 5

The following is the guacamole formula and ingredient order of addition that were used for this example, which studies the effect of pH and order of LAE addition on microbial stability:

Water, corn syrup, dry ingredients (includes citrus fiber and xanthan gum), oil phase (soybean, trans free cookie bake, polysorbate), salt. The base is homogenized and the following ingredients are added: acidified avocado, tomatillos, garlic puree, lime juice, green note flavor, cilantro, and HCl (to adjust the pH to about 3.4). This mixture goes through the votator at 175 F. The following ingredients are added after the votator: salsa, green chilies, cumin. LAE is added last.

TABLE 5
Guacamole Base Formula

| | Base Wt. % |
|---|---|
| OIL PHASE | |
| POLYSORBATE 60 | 0.1950 |
| VEGETABLE OIL | 18.5441 |
| SUB-TOTAL | 18.7391 |
| FIBER PHASE: | |
| WATER | 21.7589 |
| CITRUS FIBER | 1.7964 |
| XANTHAN GUM | 0.1678 |
| SUGAR | 0.1540 |
| CORN SYRUP | 9.2384 |
| SALT | 1.6680 |
| EDTA | 0.0072 |
| SORBIC ACID | 0.1000 |
| COLOR | 0.0616 |
| SUB-TOTAL | 34.9523 |

| FINAL MIX | % |
|---|---|
| BASE | 53.6914 |
| AVOCADO PUREE | 14.2455 |
| TOMATILLO (green tomato) | 13.9860 |
| DEHYDRATED ONION | 0.7617 |
| FROZEN GARLIC PUREE | 0.3608 |
| CONCENTRATED LIME JUICE | 0.0113 |
| SPICES and FLAVORINGS | 1.5033 |
| GREEN CHILI PEPPER | 4.9306 |
| 10% LAE in propylene glycol | 0.1000 |
| SALSA | 9.4095 |
| RED PEPPER, DEHYDRATED | 1.0000 |
| TOTAL | 100.0000 |

### EXAMPLES 5A AND 5B

This example shows the combined effect of pH, acid levels, LAE levels, as well as order of addition.

Studies “550-551” and “570-574” are summarized in the tables below. Here, xanthan gum is seen as a “quenching agent”. Also studied were the impact of pH (˜3.3 vs 3.5) and a sorbic acid increase (from 0.1 to approximately 0.2%), i.e. file “550-551” where xanthan gum was omitted from both variables, lo and then “order-of-addition” and variations in LAE and sorbic acid concentration, i.e. studies “571-574” (where LAE was added at the end of the batching process).

TABLE 6

| | | | LAE | | | Post dose |
|---|---|---|---|---|---|---|
| Formula | pH | Sorbic % | (ppm) | Xanthan | Acid | acid |
| #551 | 3.54 | 01944 | 100 | No | Phosphoric | Yes |
| #550 | 3.36 | 0.1944 | 100 | No | Phosphoric | Yes |
| #571 | 3.40 | 0.1500 | 75 | Yes | HCl | No |
| #572 | 3.40 | 0.1000 | 75 | Yes | HCl | No |
| #573 | 3.40 | 0.1500 | 100 | Yes | HCl | No |
| #574 | 3.40 | 0.1000 | 100 | Yes | HCl | No |

TABLE 7
Yeast Pool 1.48E+07 per ml Assumed 1,000,000/ml
Lactic Pool 5.18E+09 per ml Assumed 1,000,000,000/ml

| | | | Days | | | | | | | |
|---|---|---|---|---|---|---|---|---|---|---|
| | | | 0 | 7 | 14 | 28 | 42 | 56 | 70 | 84 |
| | | Calculated Inoculum | | | | | | | | |
| | | −1 | 0.0 | 1.0 | 2.0 | 4.0 | 6.0 | 8.0 | 10.0 | 12.0 |
| #550 | Lactics Hi | 5,180 | 4,000 | 900 | 2,700 | 99 | 9 | 9 | 9 | 9 |
| Guacamole | Lactics Lo | 51 | 60 | 9 | 9 | 9 | 9 | 9 | 9 | 9 |
| pH 3.36 | APRY Hi | 14,800 | 22,000 | 1,620 | 200 | 580 | 590 | 1,500 | 12,600 | 5,400 |
| | APRY Lo | 148 | 200 | 90 | 100 | 320 | 790 | 2,960 | 2,640 | 7,760 |
| | Uninoc. (PDA) | | 9 | 9 | 9 | 9 | 9 | 9 | 9 | 9 |
| | Uninoc. (MRS) | | 9 | 9 | 9 | 9 | 9 | 9 | 9 | 9 |
| | | | Days | | | | | | | |
| | | | 0 | 7 | 14 | 28 | 42 | 56 | 70 | 84 |
| | | Calculated Inoculum | | | | | | | | |
| | | −1 | 0.0 | 1.0 | 2.0 | 4.0 | 6.0 | 8.0 | 10.0 | 12.0 |
| #551 | Lactics Hi | 5,180 | 10,300 | 44,800 | 12,000 | 9 | 9 | 9 | 50 | 9 |
| Guacamole | Lactics Lo | 51 | 100 | 9 | 9 | 9 | 9 | 9 | 9 | 9 |
| pH 3.54 | APRY Hi | 14,800 | 33,100 | 4,300 | 100 | 800 | 1,560 | 2,600 | 2,900 | 5,000 |
| | APRY Lo | 148 | 610 | 30 | 244 | 102 | 2,200 | 6,900 | 9,000 | 6,160 |
| | Uninoc. (PDA) | | 9 | 9 | 9 | 9 | 9 | 9 | 9 | 9 |
| | Uninoc. (MRS) | | 9 | 9 | 9 | 9 | 9 | 9 | 9 | 9 |

75 vs 100 ppm LAE; 0.1 vs 0.15% Sorbic Acid at pH 3.4
Initiated on Day 0

| | | | Days | | | | | | |
|---|---|---|---|---|---|---|---|---|---|
| | | | 0 | 7 | 14 | 28 | 42 | 56 | 70 |
| | | Calculated Inoculum | | | | | | | |
| | | −1 | 0.0 | 1.0 | 2.0 | 4.0 | 6.0 | 8.0 | 10.0 |
| #571 | Lactics Hi | 3,420 | 6,300 | 9,000 | 38,600 | 99 | 9 | 9 | 9 |
| Guacamole | Lactics Lo | 34 | 80 | 10 | 9 | 900 | 9 | 81 | 10 |
| Formula 2.1.6 | APRY Hi | 15,000 | 10,000 | 1,060 | 340 | 21,200 | 26,800 | 36,000 | 29,000 |
| 75 ppm LAE | APRY Lo | 150 | 140 | 10 | 10 | 9 | 9 | 150 | 15,120 |
| Sorbic Acid 0.15% | | | | | | | | | |
| pH 3.46 | | | | | | | | | |
| | | | Days | | | | | | |
| | | | 0 | 7 | 14 | 28 | 42 | 56 | 70 |
| | | Calculated Inoculum | | | | | | | |
| | | −1 | 0.0 | 1.0 | 2.0 | 4.0 | 6.0 | 8.0 | 10.0 |
| #572 | Lactics Hi | 3,420 | 6,700 | 50 | 9 | 900 | 65,800 | 59,000 | 57,000 |
| Guacamole | Lactics Lo | 34 | 90 | 9 | 9 | 9 | 9 | 9 | 9 |
| Formula 2.1.7 | APRY Hi | 15,000 | 13,000 | 1,180 | 110,000 | 370,000 | 360,000 | 92,000 | 122,000 |
| 75 ppm LAE | APRY Lo | 150 | 90 | 9 | 2,560 | 134,400 | 97,000 | 88,000 | 73,000 |
| Sorbic Acid 0.10% | | | | | | | | | |
| pH 3.48 | | | | | | | | | |
| | | | Days | | | | | | |
| | | | 0 | 7 | 14 | 28 | 42 | 56 | 70 |
| | | Calculated Inoculum | | | | | | | |
| | | −1 | 0.0 | 1.0 | 2.0 | 4.0 | 6.0 | 8.0 | 10.0 |
| #573 | Lactics Hi | 3,420 | 7,800 | 9 | 9 | 60 | 9 | 9 | 9 |
| Guacamole | Lactics Lo | 34 | 10 | 9 | 9 | 60 | 9 | 9 | 9 |
| Formula 2.1.8 | APRY Hi | 15,000 | 10,300 | 680 | 50 | 9 | 33 | 2,460 | 86,000 |
| 100 ppm LAE | APRY Lo | 150 | 100 | 40 | 9 | 9 | 9 | 9 | 9 |
| Sorbic Acid 0.15% | | | | | | | | | |
| pH 3.4 | | | | | | | | | |
| | | | Days | | | | | | |
| | | | Weeks | | | | | | |
| | | | 0 | 7 | 14 | 28 | 42 | 56 | 70 |
| | | Calculated Inoculum | | | | | | | |
| | | −1 | 0.0 | 1.0 | 2.0 | 4.0 | 6.0 | 8.0 | 10.0 |
| #574 | Lactics Hi | 3,420 | 3500 | 1,440 | 24,080 | 9 | 9 | 9 | 9 |
| Guacamole | Lactics Lo | 34 | 30 | 70 | 9 | 9 | 9 | 9 | 9 |
| Formula 2.1.9 | APRY Hi | 15,000 | 12,600 | 9,900 | 179,200 | 136,000 | 284,000 | 208,000 | 2,340,000 |
| 100 ppm LAE | APRY Lo | 150 | 100 | 830 | 115,920 | 74,000 | 122,000 | 123,200 | 81,000 |
| Sorbic Acid 0.10% | | | | | | | | | |
| pH 3.4 | | | | | | | | | |

In samples 550 and 551, where xanthan gum was omitted, there was no significant increase in lactic acid bacteria or APRY yeast after twelve (12) weeks. A significant increase would be an increase of equal to or greater than 2 logs.

In samples 571 and 572, at LAE usage level of 75 ppm, there was a significant increase in APRY yeast levels and lactic acid bacteria levels, whether or not the sorbic acid level was 0.15 and 0.10%.

In samples 573 and 574, at LAE usage level of 100 ppm, the product was stabilized at the high and low lactic inoculum levels and at low APRY levels. (The low inoculum levels are expected at good GMP plants.)

While the present invention has been described herein with some specificity, and with reference to certain preferred embodiments thereof, those of ordinary skill in the art will recognize numerous variations, modifications and substitutions of that which has been described which can be made, and which are within the scope and spirit of the invention. It is intended that all of these modifications and variations be within the scope of the present invention as described and claimed herein, and that the inventions be limited only by the scope of the claims which follow, and that such claims be interpreted as broadly as is reasonable. Throughout this application, various publications have been cited. The entireties of each of these publications are hereby incorporated by reference herein.

What is claimed is:

1. A method for preserving a food composition comprising:
providing a food composition comprising an anionic polymer;
mixing said food composition with a preservative system comprising:
(a) about 20 ppm to about 200 ppm of said food composition of a cationic saturated preservative having an overall positive charge;
(b) optionally, from about 0.015 percent to about 0.500 percent by weight of said food composition of a second preservative component;
wherein said saturated preservative having an overall positive charge is added to the food composition in the last mixing step;
is thereby rendering said food composition microbiologically safe and stable.

2. The method of claim 2, wherein the food composition displays no outgrowth of Lactobacilli, acid preservative resistant yeast and mold for at least about three (3) months before opening and when kept at a temperature of 25° C. and at a pH of less than 4.2, or for at least (4) weeks before opening when kept at a pH of less than 6 at a temperature of 5° C., and prevents the outgrowth of pathogens, and achieves at least a 2 log decline of pathogens within a seven (7) day period when kept at a pH from 3.0 to less than 5.0.

3. The method of claim 1 wherein the food composition is a filling, dip, sauce, spread, dressing, refrigerated salad, batter or beverage.

4. The method of claim 1 wherein the cationic saturated preservatives suitable for use in this invention include those having the formula I: (I) 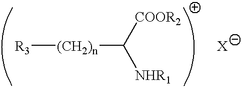
Where:
R₁ is: a linear or branched alkyl chain from a saturated fatty acid or a saturated fatty hydroxy acid containing 8 to 14 carbon atoms bonded to the alpha-amino acid group through an amidic bond;
R₂ is: a linear or branched alkyl group containing 1 to 4 carbon atoms;
X⁽⁻⁾ is: a monohydrohalide, preferably chloride (Cl⁻);
R₃ is: a structure of formula Ia 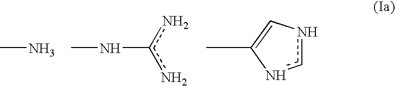
n is: from 1 to 4

5. The method of claim 1 wherein the saturated preservative is LAE.

6. The method of claim 1 wherein said second preservative component has a pKₐ of less than about 5.5.

7. The method of claim 1 wherein said second preservative component is a polyene macrolide antibiotic or a compound having the formula: 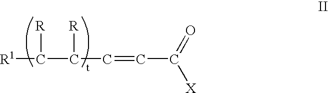
where 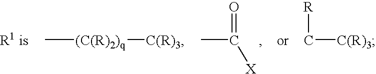
X⁽⁻⁾ is: a monohydrohalide, preferably chloride (Cl⁻);
R is independently a C₁-C₄ alkyl or hydrogen;
q is 0 to 12, and t is from 0 to 6, with the proviso that when R¹ forms part of an Sp² hybridized carbon-carbon bond, t does not equal zero.

8. The method of claim 1 wherein said second preservative component is benzoic acid, coumaric acid, salicylic acid, vanillic acid, caffeic acid, cinnamic acid, ferulic acid, salts thereof, derivatives thereof or a mixture thereof.

9. The method of claim 1 wherein the food composition or ingredients of the food composition are marinated with said saturated preservative and said second preservative component.

10. The method for preserving a food composition according to claim 1 wherein said second preservative component is selected from the group consisting of acetic, propanoic, 2-hydroxypropanoic, butyric, propionic, phosphoric, valeric, adipic, gluconic, malic, citric, tartaric, ascorbic, carnosic acid or a mixture thereof.

11. The method for preserving a food composition according to claim 1 wherein said food composition is acidified to a pH of less than about 3.6.
